(19) United States
(12) Patent Application Publication
(10) Pub. No.: US 2022/0044072 A1
(43) Pub. Date: Feb. 10, 2022

(54) SYSTEMS AND METHODS FOR ALIGNING VECTORS TO AN IMAGE

(71) Applicant: CACI, Inc. - Federal, Arlington, VA (US)

(72) Inventors: Peter S. SIMONSON, Arlington, VA (US); Tyler STAUDINGER, Denver, CO (US)

(21) Appl. No.: 17/510,448

(22) Filed: Oct. 26, 2021

Related U.S. Application Data
(63) Continuation-in-part of application No. 16/864,677, filed on May 1, 2020.

(51) Int. Cl. G06K 9/62; G06N 3/08; G06N 3/04

(52) U.S. Cl. CPC G06K 9/6256; G06N 3/0454; G06N 3/08; G06K 9/6261

(57) ABSTRACT

A system may be configured to perform label recollection, e.g., by automatically snapping, via a trained ML model, a set of vector labels by aligning one or more of the labels to an image, the alignment being performed at a quality that satisfies a criterion. Before this automatic snapping or matching of vectorized labels with reference imagery, this ML model may obtain training data from an output of another trained ML model. In another context, a computer-implemented method is disclosed for creating training data that better aligns labels with corresponding image features. This training data, created with reduced effort yet increased quality, may then be fed into to existing models, resulting in an automated pipeline.

### CROSS-REFERENCE TO RELATED APPLICATIONS

This application is a continuation in part of U.S. patent application Ser. No. 16/864,677 filed May 1, 2020, the entire content of which being incorporated herein by reference. This application also relates to U.S. patent application Ser. No. 16/864,756 filed May 1, 2020, the entire content of which being incorporated herein by reference.

### TECHNICAL FIELD

The present disclosure relates generally to practical algorithms for automatically aligning vector geodata with georeferenced satellite imagery and for creation of training data to train machine learning models.

### BACKGROUND

A user (e.g., a geospatial intelligence collections agent or analyst) may be provided different depictions of a network of existing roads. The user may have the ability to visualize sources using geographic information system (GIS) software, such as ArcGIS, QGIS, and the like. Roads play a key role in the development of transportation systems, including the addition of automatic road navigation, unmanned vehicles, and urban planning, which are important in both industry and daily living. Geospatial intelligence analysts may manually annotate images, using map software, the identified features (e.g., roads) being stored as vectors.

The training of a deep learning network may be referred to as a deep learning method or process. The deep learning network may be a neural network, Q-learning network, dueling network, or any other applicable network. Deep learning techniques may be used to solve complicated decision-making problems. For example, deep learning networks may be trained to adjust one or more parameters of a network with respect to an optimization goal. Labeling training data is a most time consuming and expensive process, e.g., in creating supervised machine learning models. Accuracy of the labeling typically suffers under time, financial, and labor resource constraints.

### SUMMARY

Systems and methods are disclosed for automatically correcting an alignment between a vector label set and a reference image, allowing analysts to complete label update tasks more rapidly, and allowing data scientists to quickly generate large volumes of accurately labeled training data. Accordingly, one or more aspects of the present disclosure relate to a method for creating training data, which may include obtaining a pixel array, visually depicting a first region of interest (ROI), and obtaining vectorized labels, descriptive of a second ROI that at least partially overlaps the first ROI; aligning, via a trained machine learning (ML) model, the vectorized labels to the pixel array at a quality that satisfies a criterion; and outputting the pixel array and the aligned labels as the training data for another ML model.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a system in which misalignment between sets of source data is repaired, in accordance with one or more embodiments.

FIG. 2A illustrates inputted reference imagery, in accordance with one or more embodiments.

FIG. 2B illustrates inputted vector feature geodata, in accordance with one or more embodiments.

FIG. 3A illustrates pixel-level feature detection, in accordance with one or more embodiments.

FIG. 3B illustrates vector labels converted to a raster, in accordance with one or more embodiments.

FIG. 4 illustrates a feature detection raster superimposed on a label raster, which are partitioned into sub-tiles, in accordance with one or more embodiments.

FIG. 5 illustrates a motion model being fit for each sub-tile, in accordance with one or more embodiments.

FIG. 6A illustrates each sub-tile motion model being translated, from pixel space to a geographic coordinate reference system, and applied to all vertices of the original vector set contained in an associated sub-tile, in accordance with one or more embodiments.

FIG. 6B illustrates original and aligned vectorized labels, in accordance with one or more embodiments.

FIG. 7 illustrates a process for repairing misalignment, in accordance with one or more embodiments.

FIGS. 8A-8B illustrate user-configurations for machine learning models, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

Presently disclosed are ways of creating training data and of automatically snapping or aligning a set of record labels to an image, e.g., at a quality that satisfies a criterion. This automatic operation technologically improves, e.g., when individual images have registration differences in being captured by different sensors from different angles (e.g., and/or when using different orthorectifications). In some embodiments, the labels may be automatically adjusted to fit with the most recent imagery available.

The herein-disclosed approach may better facilitate label recollection, which comprises obtaining a set of old labels and updating or aligning them for newly available imagery. After this update or alignment, new structures may be found or labels added, and old structures that no longer exist may be removed or their labels destroyed. As a result, this latter effort may be more efficiently performed, e.g., by avoiding spending 18 hours picking up each of many rectangles and moving them a few pixels.

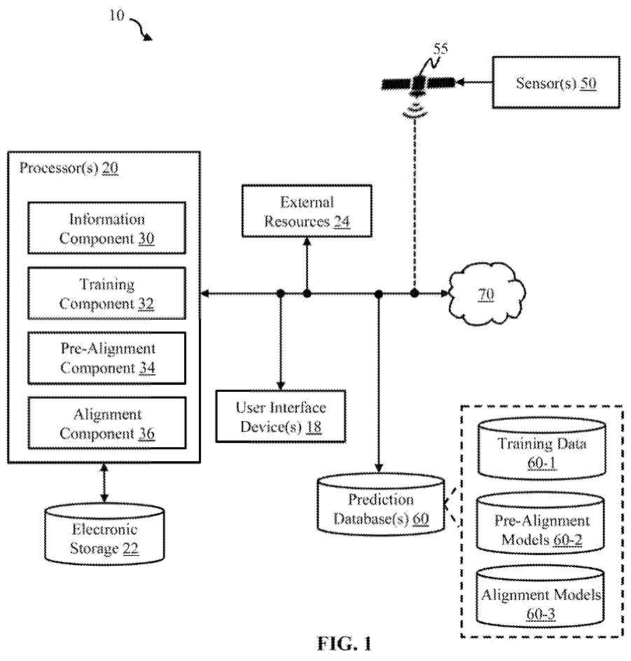

As shown in FIG. 1, processor(s) 20 is configured via machine-readable instructions to execute one or more computer program components. The computer program components may comprise one or more of information component 30, training component 32, pre-alignment component 34, alignment component 36, and/or other components. Processor 20 may be configured to execute components 30, 32, 34, and/or 36 by: software; hardware; firmware; some combination of software, hardware, and/or firmware; and/or other mechanisms for configuring processing capabilities on processor 20.

In some embodiments, processor(s) 20 may form part (e.g., in a same or separate housing) of a user device, a consumer electronics device, a mobile phone, a smartphone, a personal data assistant, a digital tablet/pad computer, a wearable device (e.g., watch), augmented reality (AR) goggles, virtual reality (VR) goggles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 20 is configured to provide information processing capabilities in system 10. Processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., one or more servers, user interface devices 18, devices that are part of external resources 24, electronic storage 22, and/or other devices).

It should be appreciated that although components 30, 32, 34, and 36 are illustrated in FIG. 1 as being co-located within a single processing unit, in embodiments in which processor 20 comprises multiple processing units, one or more of components 30, 32, 34, and/or 36 may be located remotely from the other components. For example, in some embodiments, each of processor components 30, 32, 34, and 36 may comprise a separate and distinct set of processors. The description of the functionality provided by the different components 30, 32, 34, and/or 36 described below is for illustrative purposes, and is not intended to be limiting, as any of components 30, 32, 34, and/or 36 may provide more or less functionality than is described. For example, one or more of components 30, 32, 34, and/or 36 may be eliminated, and some or all of its functionality may be provided by other components 30, 32, 34, and/or 36. As another example, processor 20 may be configured to execute one or more additional components that may perform some or all of the functionality attributed below to one of components 30, 32, 34, and/or 36.

Electronic storage 22 of FIG. 1 comprises electronic storage media that electronically stores information. The electronic storage media of electronic storage 22 may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a user interface device 18, processor 20, etc.). In some embodiments, electronic storage 22 may be located in a server together with processor 20, in a server that is part of external resources 24, in user interface devices 18, and/or in other locations. Electronic storage 22 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., RAM, EPROM, EEPROM, etc.), solid-state storage media (e.g., flash drive, etc.), and/or other electronically readable storage media. Electronic storage 22 may store software algorithms, information obtained and/or determined by processor 20, information received via user interface devices 18 and/or other external computing systems, information received from external resources 24, and/or other information that enables system 10 to function as described herein.

External resources 24 may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply, a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 24 may be provided by other components or resources included in system 10. Processor 20, external resources 24, user interface device 18, electronic storage 22, network 70, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN)), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

User interface (UI) device(s) 18 of system 10 may be configured to provide an interface between one or more users and system 10. UI devices 18 are configured to provide information to and/or receive information from the one or more users. UI devices 18 include a user interface and/or other components. The UI may be and/or include a graphical UI configured to present views and/or fields configured to receive entry and/or selection with respect to particular functionality of system 10, and/or provide and/or receive other information. In some embodiments, the UI of UI devices 18 may include a plurality of separate interfaces associated with processor(s) 20 and/or other components of system 10. Examples of interface devices suitable for inclusion in UI device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 18 include a removable storage interface. In this example, information may be loaded into UI devices 18 from removable storage (e.g., a smart card, a flash drive, a removable disk) that enables users to customize the implementation of UI devices 18.

In some embodiments, UI devices 18 are configured to provide a UI, processing capabilities, databases, and/or electronic storage to system 10. As such, UI devices 18 may include processors 20, electronic storage 22, external resources 24, and/or other components of system 10. In some embodiments, UI devices 18 are connected to a network (e.g., the Internet). In some embodiments, UI devices 18 do not include processor 20, electronic storage 22, external resources 24, and/or other components of system 10, but instead communicate with these components via dedicated lines, a bus, a switch, network, or other communication means. The communication may be wireless or wired. In some embodiments, UI devices 18 are laptops, desktop computers, smartphones, tablet computers, and/or other UI devices.

Data and content may be exchanged between the various components of the system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose, the Internet Protocol (IP) defines addressing methods and structures for datagram encapsulation. Of course, other protocols also may be used. Examples of an Internet protocol include Internet Protocol Version 4 (IPv4) and Internet Protocol Version 6 (IPv6).

In some embodiments, sensor(s) 50 may comprise one or more of a light exposure sensor or camera (e.g., to capture colors and sizes of objects), charge-coupled device (CCD), an active pixel sensor (e.g., CMOS-based), wide-area motion imagery (WAMI) sensor, IR sensor, oxygen sensor, temperature sensor, motion sensor, ultraviolet radiation sensor, haptic sensor, bodily secretion sensor (e.g., pheromones), X-ray based, radar based, laser altimeter, radar altimeter, light detection and ranging (LIDAR), radiometer, photometer, spectropolarirnetric imager, simultaneous multi-spectral platform (e.g., Landsat), hyperspectral imager, geodetic remote sensor, acoustic sensor (e.g., sonar, seismogram, ultrasound, etc.), and/or another sensing device.

In some embodiments, sensor(s) 50 may output an image (e.g., a TIFF file) taken at an altitude, e.g., from satellite 55 or an aircraft 55 (e.g., aerostat, drone, plane, balloon, dirigible, kite, and the like). One or more images may be taken, via mono, stereo, or another combination of a set of sensors. The image(s) may be taken instantaneously or over a period of time. In some embodiments, the input aerial or satellite image may be one of a series of images. For example, the herein-described approach may be applied to a live or on-demand video segment of a geographic region.

In some embodiments, information component 30 may be configured to obtain source data, via electronic storage 22, external resources 24, network 70, UI device(s) 18, a satellite database, and/or directly from sensor(s) 50. In these embodiments, these components may be connected to network 70 (e.g., the Internet). The connection to network 70 may be wireless or wired.

Artificial neural networks (ANNs) may be configured to determine a classification (e.g., type of object) or predict a value, based on input image(s) or other sensed information. An ANN is a network or circuit of artificial neurons or nodes. Such artificial networks may be used for predictive modeling. The prediction models may be and/or include one or more neural networks (e.g., deep neural networks, artificial neural networks, or other neural networks), other machine learning models, or other prediction models. As an example, the neural networks referred to variously herein may be based on a large collection of neural units (or artificial neurons). Each neural unit of a neural network may be connected with many other neural units of the neural network. Such connections may be enforcing or inhibitory, in their effect on the activation state of connected neural units. These neural network systems may be self-learning and trained, rather than explicitly programmed, and may perform significantly better in certain areas of problem solving, as compared to traditional computer programs. In some embodiments, neural networks may include multiple layers (e.g., where a signal path traverses from input layers to output layers). In some embodiments, back propagation techniques may be utilized to train the neural networks, where forward stimulation is used to reset weights on the front neural units. In some embodiments, stimulation and inhibition for neural networks may be more free flowing, with connections interacting in a more chaotic and complex fashion.

Disclosed implementations of artificial neural networks may apply a weight and transform the input data by applying a function, this transformation being a neural layer. The function may be linear or, more preferably, a nonlinear activation function, such as a logistic sigmoid, hyperbolic tangent (Tan h), or rectified linear activation function (ReLU) function. Intermediate outputs of one layer may be used as the input into a next layer. The neural network through repeated transformations learns multiple layers that may be combined into a final layer that makes predictions. This learning (i.e., training) may be performed by varying weights or parameters to minimize the difference between the predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

A convolutional neural network (CNN) is a sequence of hidden layers, such as convolutional layers interspersed with an activation function, a loss or cost function, a learning algorithm, or an optimization algorithm. Typical layers of a CNN are thus a convolutional layer, an activation layer, batch normalization, and a pooling layer. Each output from one of these layers is an input for a next layer in the stack, the next layer being, e.g., another one of the same layer or a different layer. For example, a CNN may have two sequential convolutional layers. In another example, a pooling layer may follow a convolutional layer. When many hidden, convolutional layers are combined, this is called deep stacking and is an instance of deep learning.

Convolutional layers apply a convolution operation to an input to pass a result to the next layer. That is, these layers may operate by convolving a filter matrix with the input image, the filter being otherwise known as a kernel or receptive field. Filter matrices may be based on randomly assigned numbers that get adjusted over a certain number of iterations with the help of a backpropagation technique. Filters may be overlaid as small lenses on parts, portions, or features of the image, and use of such filters lends to the mathematics behind performed matching to break down the image. That is, by moving the filter around to different places in the image, the CNN may find different values for how well that filter matches at that position. For example, the filter may be slid over the image spatially to compute dot products after each slide iteration. From this matrix multiplication, a result is summed onto a feature map.

The area of the filter may be a small amount of pixels (e.g., 5) by another small amount of pixels (e.g., 5). But filters may also have a depth, the depth being a third dimension. This third dimension may be based on each of the pixels having a color (e.g., RGB). For this reason, CNNs are often visualized as three-dimensional (3D) boxes. The disclosed convolution(s) may be performed by overlaying a filter on a spatial location of the image and multiplying all the corresponding values together at each spatial location as the filter convolves (e.g., slides, correlates, etc.) across one pixel (spatial location) at a time. In some embodiments, the filters for one layer may be of different number and size than filters of other layers. Also, the stride does not have to be one spatial location at a time. For example, a CNN may be configured to slide the filter across two or three spatial locations each iteration.

In an implemented CNN, a first convolutional layer may learn edges of an image (e.g., edges of a road). Similarly, the first convolutional layer may learn bright or dark spots of the image. A second convolutional layer may use these learned features to learn shapes or other recognizable features, the second layer often resulting in pattern detection to activate for more complex shapes. And a third or subsequent convolutional layer may heuristically adjust the network structure to recognize an entire object (e.g., recognize a road) or to better align the object recognition from within the image or a tile of the image.

After one or more contemplated convolutional layers, a nonlinear (activation) layer may be applied immediately afterward, such as a ReLU, Softmax, Sigmoid, tan h, Softmax, and/or Leaky layer. For example, ReLUs may be used to change negative values (e.g., from the filtered images) to zero. In some embodiments, a batch normalization layer may be used. The batch normalization layer may be used to normalize an input layer by adjusting and scaling the activations. Batch normalization may exist before or after an activation layer. To increase the stability of a neural network, batch normalization normalizes the output of a previous activation layer by subtracting the batch mean and dividing by the batch standard deviation.

In some embodiments, a pooling layer (e.g., maximum pooling, average pooling, etc.) may be used. For example, maximum pooling is a way to shrink the image stack by taking a maximum value in each small collection of an incoming matrix (e.g., the size of a filter). Shrinking is practical for large images (e.g., 9000×9000 pixels). The resulting stack of filtered images from convolutional layer(s) may therefore become a stack of smaller images.

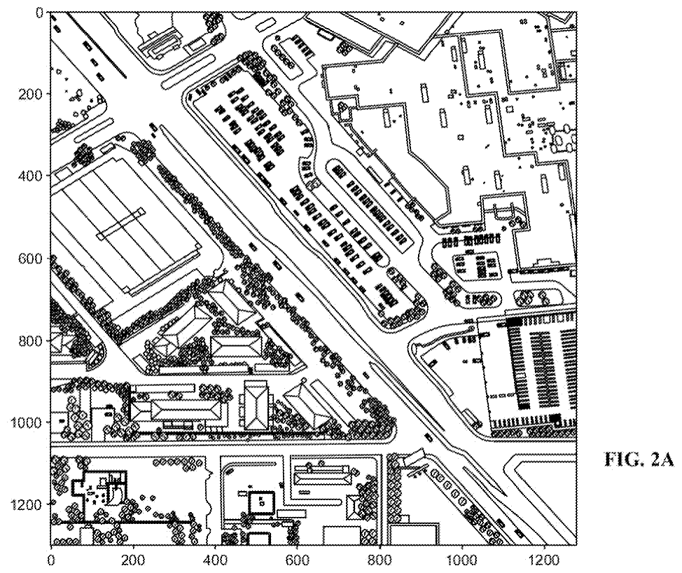

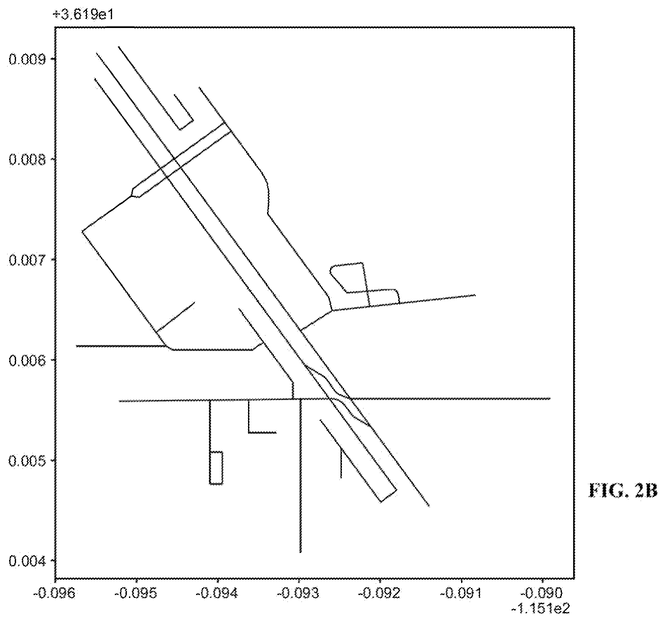

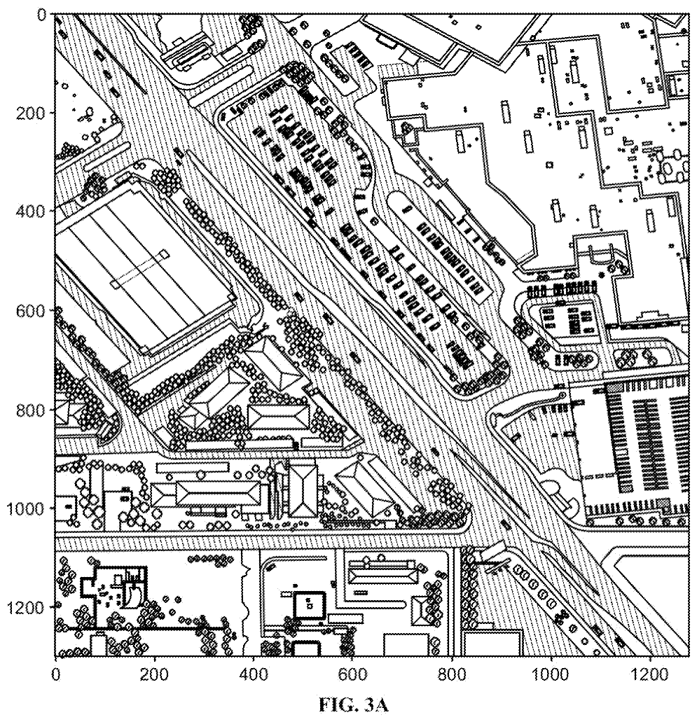

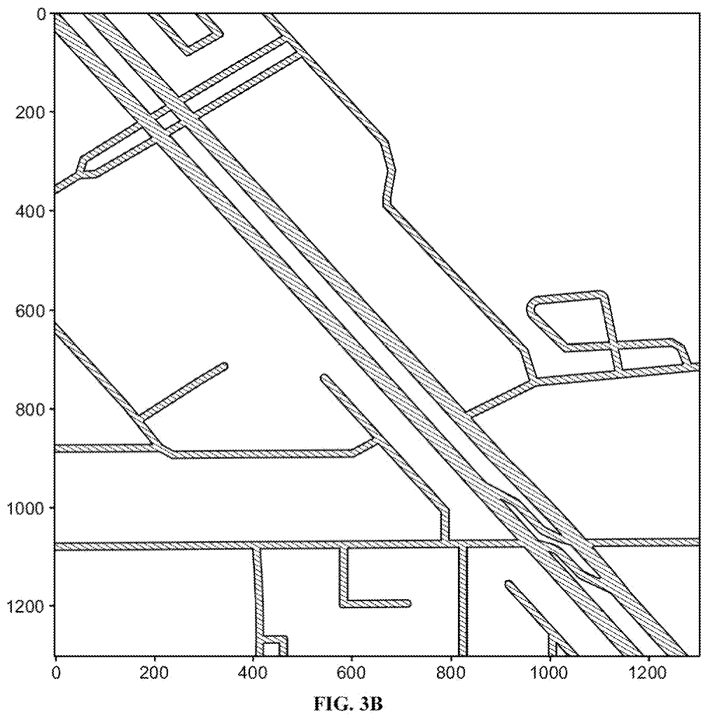

The transition from FIG. 2A to FIG. 3A may be performed via a first phase of a CNN in which feature extraction is performed from images via a combination of one or more of the mentioned layers. Then, classification or regression for prediction is performed in a second phase, e.g., via one or more fully connected layers. The final output layer of a CNN may thus be a fully connected neural network, which may precisely identify an object in the input image or identify an attribute of the object or of the image as a whole. In addition, to prevent overfitting of the image, some embodiments may use dropout, as a generalization technique. The fully connected layers may connect every neuron in one layer to every neuron in other layer(s). In direct contrast, the neurons of preceding layers in the CNN may only have local connections (e.g., with respect to nearby pixels). Before reaching the fully connected layer, some embodiments may flatten the output from a previous layer. The flattened matrix may then go through a fully connected layer for classifying at least portions of the image.

In some embodiments, system 10 may comprise a CNN that is fully convolutional. In these or other embodiments, system 10 may comprise a fully connected neural network (FCNN). Pre-alignment component 34 may apply a CNN on an input image to identify within it a particular shape and/or other attribute(s) in order to then determine whether the image comprises, e.g., road(s). Another CNN or another type of model may be used, e.g., for the herein-disclosed alignment.

The structure of the CNN (e.g., number of layers, types of layers, connectivity between layers, and one or more other structural aspects) may be selected, and then the parameters of each layer may be determined by training (e.g., via training component 32). Some embodiments may train the CNN by dividing a training data set into a training set and an evaluation set and then by using the training set. Training prediction models with known data improves accuracy and quality of outputs. Once trained by training component 32, a prediction model from database 60-3 of FIG. 1 may generate the various different predictions described herein.

Contemplated for models 60-2 and 60-3 is a support vector machine (SVM), singular value decomposition (SVD), deep neural network (DNN), densely connected convolutional networks (DenseNets), hidden Markov model (HMM), Bayesian network (BN), R-CNN, Fast R-CNN, Faster R-CNN, mask R-CNN, mesh R-CNN, region-based fully convolutional network (R-FCN), you only look once (YOLO) network, RetinaNet, singe shot multibox detector (SSD), and/or recurrent YOLO (ROLO) network.

In some embodiments, training data 60-1 may be any suitable corpus of images or video, e.g., which may include hundreds or even thousands of different categories. For example, dataset 60-1 may have around 800 classes in the training set and 200 classes in the test set, and the classes that are in the test set may actually not be represented in the training set. So, there may be no categorical overlapping between training and test, e.g., which may be significant in ascertaining whether a model of database 60 is working properly.

Each of the herein-disclosed ANNs may be characterized by features of its model. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. And the hyperparameters are set before learning, and model parameters can be set through learning to specify the architecture of the ANN.

Learning rate and accuracy of each ANN may rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters. The hyperparameters may include initial values of weights and biases between nodes, mini-batch size, iteration number, learning rate, and so forth. Furthermore, the model parameters may include a weight between nodes, a bias between nodes, and so forth. In general, the ANN is first trained by experimentally setting hyperparameters to various values, and based on the results of training, the hyperparameters can be set to optimal values that provide a stable learning rate and accuracy.

Artificial neurons may perform calculations using one or more parameters, and there may be connections from the output of one neuron to the input of another. The extracted features from multiple independent paths of attribute detectors may, e.g., be combined.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

In some embodiments, the learning of models 60-2 and/or 60-3 may be of a reinforcement, deep reinforcement learning (DRL), supervised, and/or unsupervised type. For example, there may be a model for certain predictions that is learned with one of these types while another model for other predictions may be learned with another of these types.

Supervised learning is the machine learning task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which can be used for mapping new examples. And the algorithm may correctly determine the class labels for unseen instances.

Unsupervised learning is a type of machine learning that looks for previously undetected patterns in a dataset with no pre-existing labels. In contrast to supervised learning that usually makes use of human-labeled data, unsupervised learning does not via principal component (e.g., to preprocess and reduce the dimensionality of high-dimensional datasets while preserving the original structure and relationships inherent to the original dataset) and cluster analysis (e.g., which identifies commonalities in the data and reacts based on the presence or absence of such commonalities in each new piece of data). Semi-supervised learning is also contemplated, which makes use of supervised and unsupervised techniques.

Training component 32 of FIG. 1 may prepare one or more prediction models 60-2 and/or 60-3 to generate predictions. Models 60-2 and/or 60-3 may analyze made predictions against a reference set of data called the validation set. In some use cases, the reference outputs may be provided as input to the prediction models, which the prediction model may utilize to determine whether its predictions are accurate, to determine the level of accuracy or completeness with respect to the validation set data, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model. In some embodiments, UI devices 18 may be used by a user to configure aspects of models 60-2 and/or 60-3.

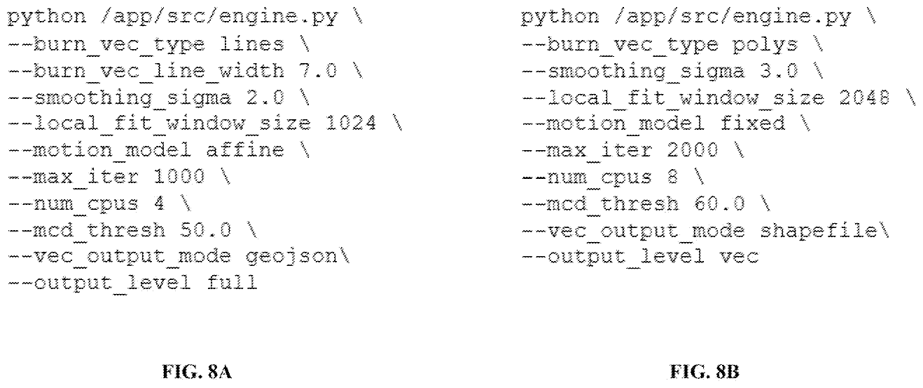

FIGS. 8A-8B depict two examples of how a user, e.g., via UI devices 18, may configure tool operation. FIG. 8A may be configured to operate on lines (e.g., roads), with line vectors converted or burned to rasters with a fixed width of 7.0 meters, a smoothing kernel applied to both signals with a standard deviation of 2.0 meters, local fitting windows of 1024×1024 pixels, 1000 iterations used to fit the motion model parameters, operations parallelized across 4 CPUs, a transformation size filter of 50 meters (mean corner displacement), and outputting files in GeoJSON format, with both the prime output of interest, as well as support files being generated.

FIG. 8B may be configured to operate on polygons (e.g., buildings), a smoothing kernel applied to both signals with a standard deviation of 3.0 meters, local fitting windows of 2048×2048 pixels, 2000 iterations used to fit the motion model parameters, operations parallelized across 8 CPUs, a transformation size filter of 60 meters (mean corner displacement), and outputting files in shapefile format, with only the prime output of interest generated.

A model implementing a neural network may be trained using training data obtained by information component 30 from training data 60-1 of storage/database 60. The training data may include many attributes of objects or other portions of a content item. For example, this training data obtained from prediction database 60 of FIG. 1 may comprise hundreds, thousands, or even many millions of pieces of information (e.g., images or other sensed data) describing objects. The dataset may be split between training, validation, and test sets in any suitable fashion. For example, some embodiments may use about 60% or 80% of the images for training or validation, and the other about 40% or 20%, respectively, may be used for validation or testing. In another example, training component 32 may randomly split the labelled images, the exact ratio of training versus test data varying throughout. When a satisfactory model is found, training component 32 may, e.g., train it on 95% of the training data and validate it further on the remaining 5%.

The validation set may be a subset of the training data, which is kept hidden from the model to test accuracy of the model. The test set may be a dataset, which is new to the model to test accuracy of the model. The training dataset used to train prediction models 60-2 and/or 60-3 may leverage, respectively via component 34 and/or 36, an SQL server, and/or a Pivotal Greenplum database for data storage and extraction purposes.

In some embodiments, training component 32 may be configured to obtain training data from any suitable source, via electronic storage 22, external resources 24 (e.g., which may include sensors), network 70, and/or user interface (UI) device(s) 18. The training data may comprise captured images, smells, light/colors, shape sizes, noises or other sounds, and/or other discrete instances of sensed information.

In some embodiments, models 60-2 may be used, e.g., to produce georeferenced vector labels corresponding to transport networks in a particular geographic region.

In some embodiments, pre-alignment model 60-2 may be used, in a raster phase, to read an input image and convert a pixel map mask into rough, skeleton vectors. In a subsequent vector phase, a quality and shape of the vectors may be improved, and undesirable artifacts may be removed. A shape may be described with a list of vertices. Objects in a shapefile format may be spatially described vector features, such as coordinates associated with each of points, lines, and polygons, each of which potentially representing a different type of object. A file of this type may thus comprise a list or table of starting and ending points, each object instance being in a coordinate system (e.g., based on X and Y axes or any other set of axes).

The raster phase may comprise a set of operations, including reading a tile from an input image, morphological cleanup, skeletonization, truncating an overlap from the tile, vectorization, removing segments on right/bottom boundaries, smoothing, pre-generalization, and/or gathering vectors from all tiles. And the vector phase may comprise another set of operations, including creating a connectivity graph, cluster collapsing, gap jumping, spurs' removal, joining unnecessary graph splits, intersection (e.g., quad, T, circle, and/or another type of intersection) repair, post-generalization (e.g., vertex reduction), and/or transforming and outputting.

In some embodiments, pre-alignment model 60-2 may comprise a ResNet-101 CNN backbone. In these or other embodiments, the model may comprise a DeepLabV3 network head, which may be attached to the network and configured to produce the pixel maps (e.g., including a segmentation operation).

The pixel map may include pixels, each of which indicating whether it is part of a certain type of object (e.g., a road). More particularly, thresholding may be performed to obtain an image output (e.g., a pixel map) that has a binary value assigned to each pixel. Each pixel with a binary value may indicate, e.g., whether the pixel forms part of a particular object type (e.g., road, building, etc.). As an example, the initial layers of a CNN (e.g., convolutional layer, activation, pooling) may be used to recognize image features. The CNN may be obtained from models 60-3 of FIG. 1. That is, after training component 32 trains the neural networks, the resulting trained models may be stored in models 60-3 (and/or models 60-2) storage/database. Some implementations of system 10 may obtain a different model for a plurality of different attributes to be detected. Image features of the image may be determined by using the obtained ANN (e.g., the CNN). Image feature values may represent visual features of one or more aspects of the image. A feature may be an interesting part of an image. For example, features or patterns may be one or more of textures, edges, corners, regions, shadings, shapes, ridges, straight lines, crosses, T-junctions, Y-junctions, or other characteristics of the image. Some embodiments may only examine the image in the region of the features whereas others may examine all pixels of the image.

A pixel map may be predicted, via a machine learning model, using an inputted image. As an example, advancements in machine learning and geospatial software development may be used to automate the task of aligning extracted roads (e.g., two-dimensional geospatial vector data) with aerial imagery.

FIG. 2A depicts an inputted 1,300×1,300 pixel map (e.g., of a map, chart, etc.) of reference imagery (e.g., which may have a registration error). FIG. 3A depicts automatic road extraction from such high-resolution optical, remote-sensing imagery. The raster of FIG. 3A may exemplarily comprise binary values e.g., which encode foundational GEOINT features or representations of a geographic and/or global features having at least one of spatial representation(s), shape(s), and a set of attributes. For example, each pixel may be (i) colored (e.g., white), form part of white-filled polygon, or otherwise emphasized, where there are no roads present but instead manufactured structure, or (ii) colored differently (e.g., black), form part of hatching or a circle, or otherwise emphasized, where there are roads or other structure present, as depicted in FIG. 3A. Such road extraction, though, may be considered noisy due at least to road structures, complex backgrounds, heterogeneous regions, and blockages by obstacles either through shadow occlusion or visual occlusion.

FIG. 2B depicts vectors, within which geo-intelligence (GEOINT) features may be encoded, e.g., with each road being interpretable as one pixel thick. A feature may be defined herein as a foundational GEOINT feature or a representation of a geographic or global feature that has at least a spatial representation (i.e., a shape) and a set of attributes. These features may take the form of maps, charts, or other data. And such vector data may comprise vertices and paths (e.g., points, lines, polygons, or a 3D shape), with spatial coordinates.

In some embodiments, the x and y axes of initial vector sets (e.g., depicted in FIG. 2B without any pixel space and rather just spatial coordinates) may be for spatial geo-referencing (e.g., latitude and longitude addresses). In some embodiments, by knowing where each pixel in the image is in space, pre-alignment component 34 may convert or burn from a spatial location to a pixel location in generating a raster. For example, by knowing the conversion between geographic reference space and pixel space and by knowing that a line travels between geographic point A and geographic point B, pre-alignment component 34 or alignment component 36 may determine which pixels that line will travel through in pixel space; those pixels may then be turned on, in knowing that the line goes through those pixels.

The thickness of the mentioned lines may be greater than one pixel (e.g., at certain locations) and may be determined based on the image feature (e.g., type of road) it represents. For example, FIG. 3B depicts a rasterization of the vector data, e.g., with different lines having different thicknesses in terms of pixels. A raster may be a set of horizontal lines composed of individual pixels in grid cells, and it may be used to form an image on a screen.

In some embodiments, pre-alignment component 34 may truncate one or more vector labels at locations that extend beyond the ROI of the image, e.g., by first translating the set of vectorized labels into pixel space. For example, the ROI is determined based on a portion of inputted reference imagery, which may include metadata indicating the spatial extent of the image in a particular coordinate reference system such that component 34 causes the labels to exactly fit that image. In other embodiments, the ROI is determined based on a portion of inputted vector feature geodata such that any necessary truncation is inversely performed at locations of the imagery that extend beyond the ROI of the labels.

In some embodiments, information component 30 may obtain an orthophoto, orthophotograph, or orthoimage as an aerial photograph or satellite imagery geometrically corrected (i.e., orthorectified) such that the scale is uniform. Unlike an uncorrected aerial photograph, an orthophoto can be used to measure true distances, because it is an accurate representation of the Earth's surface, having been adjusted for topographic relief, lens distortion, and camera tilt.

In some embodiments, information component 30 may obtain vectorized feature datasets of labels (e.g., roadway centerlines, building footprint polygons, etc.), which may not align well with a current satellite image of a particular ROI; this misalignment may be due to shot angle, orthorectification scheme, resolution, or other differences between the old imagery used to collect the database and the current imagery.

In some embodiments, the vectorized labels are depicted in the baseline visualization of FIG. 2B, e.g., with a line drawn therein along the centerline of each road or pavement portion. In this example, a set (e.g., one or more) of lines may have attached an attribute that indicates the road, e.g., as being 2, 3, or 5 meters wide or as being a certain amount of lanes wide. For example, by knowing the geographic location and that attribute, a label raster (e.g., of FIG. 3B) may be drawn or otherwise representative of features in an image. In another example where that attribute is unknown, the label raster may depict a feature by estimating a parameter, such as a width of corresponding lines.

In some embodiments, the feature detection raster (e.g., FIG. 3A) may depict unclean, noisy, or irregularly shaped polygons or a set of pixels based on (i) feature extraction, using another ML model, or (ii) feature detection, using known computer vision functionality; and, in these or other embodiments, the label raster (e.g., FIG. 3B) may depict a clean set of geometry for the roads, manufactured structure (e.g., buildings), and/or natural objects (e.g., vegetation). Exemplary feature detection may involve use of a computer vision (OpenCV) library of programming functions and/or the Python image library (PIL), to identify features of interest based on an input image.

In the example of FIG. 3A, circles are used to represent foliage or vegetation, other polygons filled with white are used to represent manufactured structure (e.g., buildings, cars, median of a street, etc.), and hatching is used to represent portions of road and/or pavement. In the example of FIG. 3B, hatching is used to represent portions of road and/or pavement.

In some embodiments, information component 30 may obtain geo-data and obtain geo-referenced imagery, from one or more sources. Geo-data may comprise geometric information in a format (e.g., spreadsheet). As such, the geo-data may comprise a plurality of rows of geographic information, such as point locations in a coordinates' list. While geo-data may not have any actual imagery data associated with it, geo-referenced imagery may encode its data in imagery form. In some embodiments, information component 30 may obtain geometry and vectorized road networks each with a certain quality.

In an example of geo-data, a road may be represented as two lines extending between point A, to point B, to point C, each point having a geometric location and associated attribute descriptors that are stored. In an example of geo-imagery, a road may be represented with a raster graphics image that has embedded georeferencing information. Georeferencing implies an internal coordinate system of a map or aerial image being related to a ground system of geographic coordinates. In other words, georeferencing implies associating a physical map or raster image of a map with physical, spatial locations.

In some embodiments, information component 30 may obtain data objects from semantically segmented satellite imagery. For instance, information component 30 may obtain a vectorized pixel map (e.g., FIG. 2B), which may originally be determined from an image of a city block and which the pixel map may be converted into two-dimensional vectors. This pixel map may show what type or class of object each pixel in the image is part of (e.g., road, background, etc.). Each of the vectors may comprise one or more points, lines, vertices, and/or polygons.

In some embodiments, information component 30 may obtain vectorized labels (e.g., open-source labels, such as from the open-source collaborative mapping OpenStreetMap (OSM)). These labels may serve as detected references of an initial alignment, and they may not be annotated with a high degree of quality. For example, the alignment between the labels and image features may have significant mismatches. Accordingly, alignment component 36 may obtain such labels that are otherwise unusable and turn them into labels that are usable as training data.

Additionally, system 10 may allow data scientists to exploit both open-source label databases (e.g., representing hundreds of thousands of hours of crowd-sourced labeling effort) and lower-precision proprietary databases (e.g., created internally as part of previous label delivery efforts) to create feature detection training data. These otherwise unusable sources (e.g., due to poor alignment with imagery) may be made usable by the herein-disclosed approach, without requiring hundreds of hours of manual adjustment. With improved training data, stronger ML detectors may be created, allowing for high precision automated feature extraction over a wide variety of geography and terrain.

In some embodiments, information component 30 may obtain a georeferenced image and a vector geodata (e.g., from OSM road data) feature set. Next, training component 32 may train models 60-3. And then alignment component 36 and models 60-3 may take as input the georeferenced image and the vector geodata feature set, the latter of which is to be aligned with said image. Then, alignment component 36 may return a version of the vector geodata that has been aligned to match the features in the image. The process may be encoded end-to-end with a neural network.

The image(s) obtained by information component 30 may be georeferenced, e.g., in the sense that a latitude and longitude may be known for each different pixel or set of pixels. In another example, the georeferencing may comprise a universal transverse mercator (UTM) coordinate reference system to indicate where in space the pixels are.

In some embodiments, information component 30 may download an ROI or entire satellite imagery (e.g., from a satellite database into storage 22) and then upload the ROI or the entire image into local GPUs (e.g., an NVIDIA DGX-1 server).

In some implementations, a production environment (e.g., in which ML model 60-3 is trained and deployed), the imagery may be the most recent from among a first dataset comprising a pixel array and a second dataset comprising vectorized labels. For example, the image may more recently represent (e.g., capture) a ROI than the vectorized labels. In these or other implementations, the misalignment may be detected based on specific guidelines, e.g., where labels are acceptable as long as the labels are within an amount of (e.g., 5) meters from the imagery feature.

In implementations involving creation of training data, each of the pixel array and the vectorized labels may be indiscriminately inputted from an external source. For example, information component 30 may obtain any pixel array and/or any vectorized labels from whichever source that may communicably supply the dataset(s). In these or other implementations, the misalignment may be off by more than a pixel or two, such as instances that are substantially obvious (e.g., upon initial observation).

In some embodiments, by correcting input data and thus producing higher quality training data, the models (e.g., feature detectors) that are trained with this higher quality data may become stronger. In these or other embodiments, this cycle of inputting training data, improving the quality of that data, and then re-training a model may be iterative to continuously obtain a model that predicts better aligned labels on more and more data.

In some embodiments, training component 32 may enable one or more prediction models 60-2, 60-3 to be trained. The training of the neural networks may be performed via several iterations. For each training iteration, a classification prediction (e.g., output of a layer) of the neural network(s) may be determined and compared to the corresponding, known classification. In implementations involving an end-to-end neural network, both classification and regression tasks may be used to perform this overall function.

In an example, sensed data known to capture an environment comprising dynamic and/or static objects may be input, during training or validation, into the neural network, e.g., to (i) predict, via model 60-2, vectorized labels indicating an object's presence at an initial alignment quality and (ii) predict, via model 60-3, a position realignment for sets of original vector feature geodata. As such, the neural networks may be configured to receive at least a portion of the training data as an input feature space. Once trained, the model(s) may be stored in database/storage 60, as shown in FIG. 1, and then used to classify samples of images based on attributes.

In some embodiments, training component 32 and/or another component of processors 20 may cause implementation of deep learning. The deep learning may be performed via one or more ANNs.

Mismatch between a label and a corresponding image feature causes increased costs and time for label database update/recollection efforts, which may detract from more important tasks, e.g., of creating/removing labels for newly constructed/destroyed features. The mismatch renders the label/imagery pairs unsuitable for use in training machine learning-based computer vision models, e.g., which may figure out which pixels of this image are buildings, roads, or another image feature. Such models may be trained using examples or ground truth (e.g., where pixels in a given picture are examples of buildings or where pixels in the picture are examples of roads). In some embodiments, the herein-disclosed label recollection may be a foundation GEOINT service, e.g., to reconcile differences between old imagery used to collect the database and current imagery of substantially a same ROI.

Label alignment issues harm related technology by badly training the model (e.g., when pixels that are actually to the right of a building in an image are incorrectly indicated to be building pixels, and pixels along the left edge of the building are incorrectly indicated not to be building pixels; a model trained on such data may learn to reproduce this error in future predictions). This poor training may result in pre-alignment model 60-2 that badly identifies building and/or road pixels. Such low-quality data may be unsuitable for use as training data, before applying system 10 to them; after this application of model 60-3 performed at a sufficient level of quality, outputted training data may be made suitable for use by downstream models.

In some embodiments, alignment component 36 may enable completion of relabeling efforts (e.g., commissioned by national geospatial-intelligence agency (NGA) and/or other government agencies) at a greater speed (e.g., by minimizing labor involved). For example, label mismatch or misalignment may otherwise require an analyst to spend time aligning old labels, which are otherwise correct, with new imagery. The herein disclosed relabeling due to misalignment, though, may result in better quality. For example, a human analyst may otherwise pick up a shape and physically shift it to a new location. While, in some instances, that may be sufficient, alignment component 34 may cause objects to be picked up and moved to a more accurate location, but this component via model 60-3 may also mildly deform the objects if needed.

As such, the herein-disclosed approach may perform simple translations (e.g., pick up and drag) but also more complex operations, such as a skew function. For example, the skew operation may result in individual vertices being repositioned. But alignment component 36 may cause other operations, such as elastic deformations, which would be impractical if required to be done manually for dozens or hundreds of objects instances. With a high-quality detector providing the input datasets to alignment component 36, the herein-disclosed alignment operations may result in annotations that are more accurate than any known techniques.

In some embodiments, alignment component 36 may interoperate with ML model 60-3 to rapidly (e.g., within hours) create training data for another ML model (e.g., model 60-2). For example, pre-alignment model 60-2 may initially predict computer vision (CV) features, and then use the created training data for re-training its ability to predict those features. In this or another example, alignment model 60-3 may predict quantities of pixels for adjusting a position of certain mis-aligned vectorized labels inputted by information component 30.

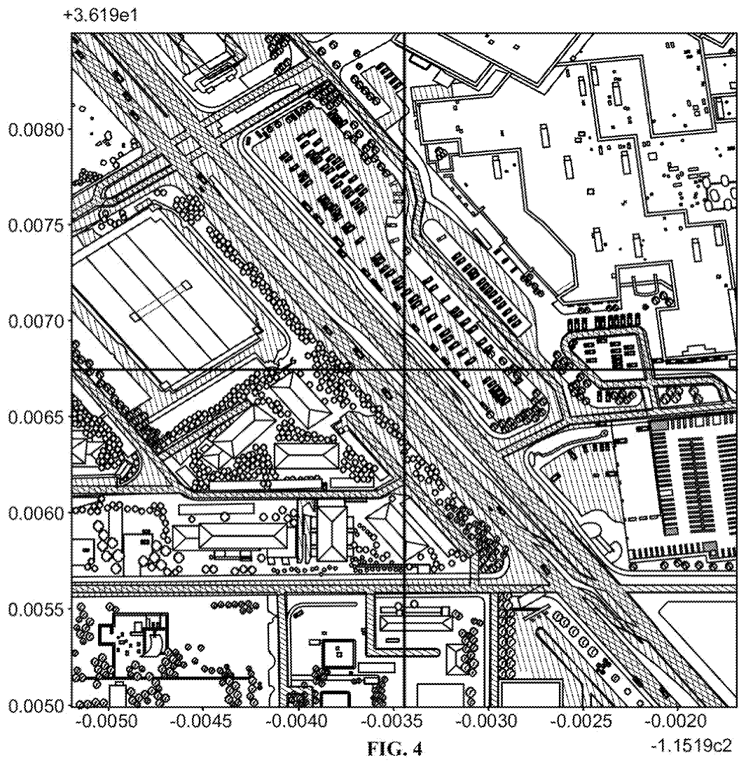

In some embodiments, alignment component 36 and models 60-3 may determine a transformation, which aligns the overlaid rasters of FIG. 4 (or the pre-overlaid rasters of FIGS. 3A-3B). For example, a mapping between the coordinate systems of these two rasters may be determined. In these or other embodiments, a similarity measure, the enhanced correlation coefficient, may be adopted as an objective function for the alignment. The measure may be invariant to photometric distortions in contrast and brightness, and an iterative function of the parameters may be linear, thus requiring reduced computational complexity.

In some embodiments, the alignment may be performed by estimating parameters p such that: Iᵣ(x)=I_{w}(Φ(x; p)), ∀x∈ T. For obtaining a unique solution, it may be that the number N of unknown parameters does not exceed the number K of target coordinates. A criterion to quantify the performance of the warping transformation with parameters p may be:

$${E}_{E C C} ( p ) = {‖ \frac{{\overline{i}}_{r}}{‖ {\overline{i}}_{r} ‖} - \frac{{\overline{i}}_{w} ( p )}{‖ {\overline{i}}_{w} ( p ) ‖} ‖}^{2}$$

where ∥⋅∥ denotes the usual Euclidean norm. It is apparent from this equation that the criterion is invariant to bias and gain changes. And it may suggest that the measure is going to be invariant to any photometric (and geometric) distortions in brightness and/or in contrast.

Once the performance measure is specified, it may be minimized to compute the optimum parameter values. It is straightforward to prove that minimizing E_{ECC}(p) is equivalent to maximizing the following enhanced correlation coefficient:

$$ρ ( p ) = \frac{{\overline{i}}_{r}^{t} {\overline{i}}_{w} ( p )}{‖ {\overline{i}}_{r} ‖ ‖ {\overline{i}}_{w} ( p ) ‖} = {\overline{i}}_{r}^{t} \frac{{\overline{i}}_{w} ( p )}{‖ {\overline{i}}_{w} ( p ) ‖}$$

where, for simplicity, îᵣ=Īᵣ/∥īᵣ∥ is denoted the normalized version of the zero-mean reference vector, which may be constant. The maximization may require nonlinear optimization techniques.

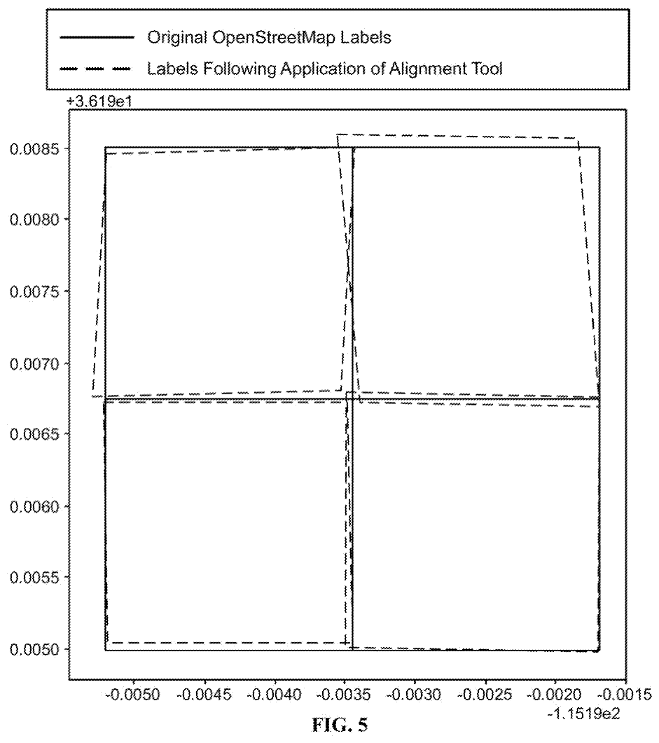

FIG. 5 depicts an example of localized transformations, each being applied to the labels in each sector, sub-tile, quadrant, or partition of the feature detection raster (e.g., at least a portion of the image in FIG. 3B). In this example of FIG. 5 are shown (i) the initial, original rectangles with solid lines at the edges and (ii) the transformative rectangles, each showing different transformations to be applied (e.g., to vectorized labels) with dotted lines at the edges. More particularly, the upper-right sub-tile in this example of FIG. 5 is more aggressively transformed than the lower left or lower right sub-tile.

In some embodiments, the transformation or alignment adjusts the labels by moving at least some of them towards the reference imagery (e.g., pixel array). In other embodiments, the transformation or alignment adjusts the reference imagery by moving at least some pixels thereof towards the vectorized labels. In yet other embodiments, a combination of adjustments may be performed (e.g., by moving the reference imagery and the vectorized labels towards each other).

The herein-disclosed transformations may result in realignments that elastically adjust (e.g., extend out or pull in) sub-tile boundaries such that the labels respectively within better line up with the feature they respectively describe or indicate. For example, a grouping of vectorized labels in a sub-tile can be optimally adjusted all at once rather than manually adjusting each vertex of each polygon in that region of the sub-tile. This may be significant, e.g., when creating training data.

In some embodiments, geodata may be inherited from the imagery provider. For example, corresponding metadata may be attached and thus obtained when obtaining a GeoTIFF (e.g., satellite or aerial) from a satellite image provider. In this or another example, an upper left-hand corner of an image, e.g., at pixel 0, 0 may correspond to coordinates of latitude x, longitude y, and a lower right corner of the image, e.g., at pixel 10,000, 10,000 may correspond to coordinates of latitude x′, longitude y′. And information component 30 may obtain from the satellite image provider either a transform or ground control points (GCP).

In some implementations, geodata may have an implicit or explicit association with a location relative to Earth. Location information may be stored in a geographic information system (GIS), e.g., in proximity to geographic databases.

In some embodiments, information component 30 may obtain geo-labels, which may be a set of points in space. In these or other embodiments, alignment component 36 may (e.g., slightly) adjust those labels to better line-up with the corresponding feature in the imagery. For example, ML model 60-3 may use imagery geodata as a basis and then alter the geodata that is in the labels. In this or another example, the shifting amount for each label may be the same. In yet another example, different portions of the labels may be shifted different amounts.

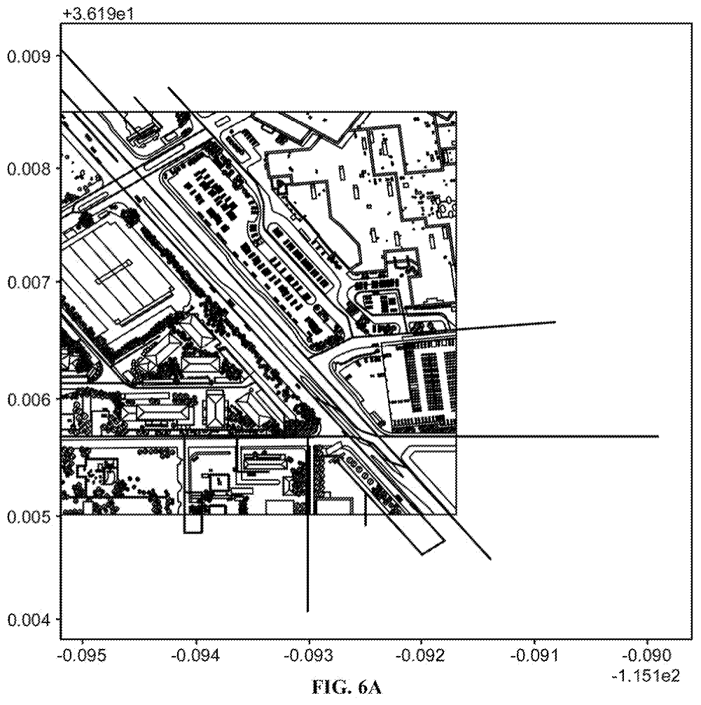

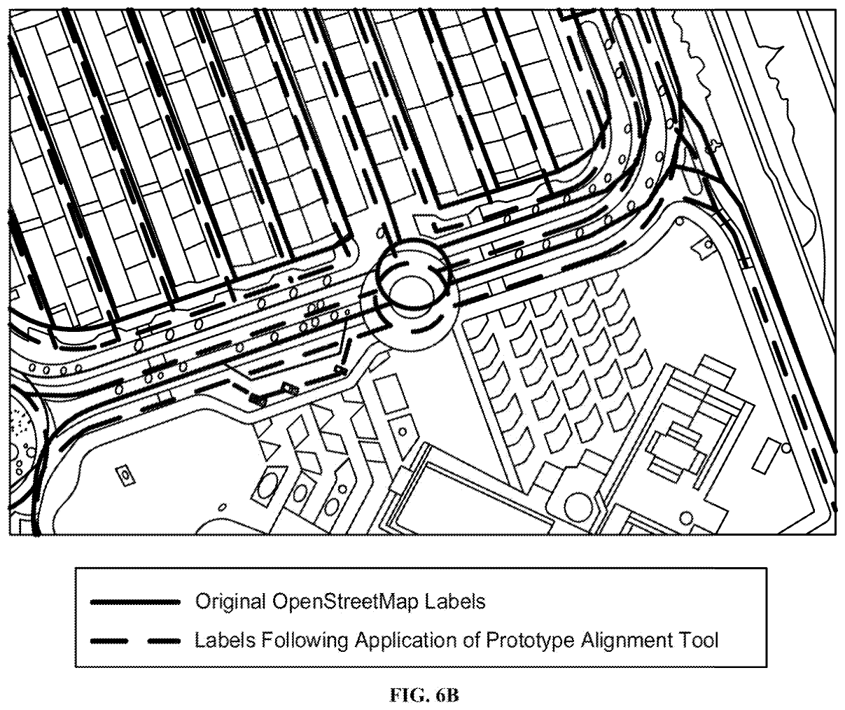

Each of FIGS. 6A-6B depicts a resultant attempt to correct poorly aligned labels (e.g., road lines from OSM, which is an open-source database) with respect to a satellite image.

In some embodiments, the shifting algorithm is configurable. For example, a basic shift may be performed; but in other examples the basic shift may be insufficient in terms of quality. Accordingly, FIG. 6B depicts the labels with vectors that are better aligned via different adjustments in different portions of the same image (e.g., with the seeming triangular portion in the upper right side of the image having a greater distance and different direction between the solid and dotted lines than between parallel lines/roads in the upper left side of the image). In these or other embodiments, alignment component 36 may flexibly transform labels over space (e.g., a coordinate system), e.g., to accommodate the way that misalignments actually occur in the dataset.

In some embodiments, alignment component 36 and models 60-3 may cause better alignment between the reference image (e.g., FIG. 2A) and the vectorized labels (e.g., FIG. 2B). As shown in the example of FIG. 6B, alignment may be performed by starting with the vector set, which is depicted with solid lines, and resulting in a transformation to the vector set, which is depicted with dotted lines.

In some embodiments, information component 30 may obtain a first dataset comprising reference imagery and obtain a second dataset comprising vector feature geodata. Next, pre-alignment component 34 may perform pixel-level feature detection; this can take the form of either classic computer vision or more modern machine learning algorithms. At substantially a same time, pre-alignment component 34 may burn vector labels to a raster, e.g., with the same spatial extent as the reference image.

Then, pre-alignment component 34 may overlay (e.g., via trained ML model 60-3) the feature detection raster and the label raster, and partition (e.g., via trained ML model 60-3) the overlaid rasters into sub-tiles. And then alignment component 36 may fit a motion model for each of the sub-tiles, aligning the label raster with the detection raster using an ECC algorithm. A sub-tile may comprise at least a polygonal portion of a larger image or raster, which may itself be a tile. In the example of FIG. 4, four sub-tiles are shown, but any natural number of sub-tiles is contemplated.

Finally, alignment component 36 may translate (e.g., via linear algebra and/or a matrix operation) each sub-tile motion model from pixel space to the geographic coordinate reference system and may apply the respective sub-tile motion model to all vertices of the original vector set contained in the respective sub-tile. This may result in a vector label set that is better aligned with the reference image.

In some embodiments, the alignment may be performed by automatically snapping or aligning the vectorized labels to an image. For example, the automatic snapping or aligning may be performed via a vector that is different at a region of the image from another vector at another region of the image. In this or another example, the transforming may be performed by initially preprocessing imagery or vectorized labels, e.g., where the imagery is far off from respective labeling.

In some embodiments, alignment component 36 and/or models 60-3 may apply transformations to polygon labels. In some embodiments, a motion model may describe the type of mathematics applied to make that transformation. For example, a used motion model may be simpler (e.g., a pickup, moving, and put down of the set of labels without any position twisting). In this or another example, a used motion model may be more complicated (e.g., an affine transformation, involving (i) an x-y coordinate translation or shift and (ii) a skew or sheer motion, or a sixth degree of freedom transformation). A herein-contemplated geometric transformation may preserve lines and parallelism (but not necessarily distances and angles), and an example of a contemplated affine transformation may include a translation, scaling, homothety, similarity, reflection, rotation, and/or shear mapping.

In some embodiments, the motion models that are fitted operate in pixel space. For example, alignment component 36 may determine that a pixel (e.g., at location 0,0 in pixel space) needs to be moved to another pixel (e.g., at location 1,2 in the new pixel space). But, since the movement relates to a transformation from a geographic coordinate reference system, component 36 may convert the transformation that mathematically works on pixel addresses into a transformation that works on geographic addresses (e.g., such that the movement is from latitude, longitude 1.20, 3.40 to latitude, longitude 1.25, 3.47). Accordingly, the motion model may be adjusted so that it works on geographic objects as opposed to pixels objects.

In some embodiments, alignment component 36 and models 60-3 may implement an ECC algorithm, e.g., which obtains two images and fits a transformation such that the images are better aligned according to another transformation model that is fit. These two images may be rasters, such as the feature detection raster, in the example of FIG. 3A, and the label raster, in the example of FIG. 3B. As such, the raw input imagery of FIG. 2A is initially converted into the image of FIG. 3A, and the polygon labels of FIG. 2B are initially rasterized into the image of FIG. 3B that can be compared with the converted image of FIG. 3A and then aligned.

In some embodiments, alignment component 36 and models 60-3 may perform preprocessing (e.g., a kernel smoothing operation) of the imagery when the labels are misaligned by a predetermined amount. In these or other embodiments, alignment component 36 and models 60-3 may perform postprocessing, such as by obtaining that transformation that was learned on the image side and then convert that back to a transformation that can be applied to the polygon labels. Then, that transformation may be applied to the polygon labels.

In some embodiments, information component may obtain vector feature geodata outputted from an existing deep learning model (e.g., model 60-2) as reference for the alignment operation, resulting in an alignment that can be significantly better, e.g., since the ECC algorithm may then operate over fewer irrelevant pixels. For example, the ECC algorithm may be applied to an output of a neural network to reinforce or improve alignment of the data.

In some embodiments, training component 32 may train models 60-3 to put one or more of the mentioned preprocessing, the ECC algorithm itself, and the mentioned postprocessing into that neural network. In these or other embodiments, one or more of the mentioned overlaying of rasters, portioning of the overlaid rasters, and the mentioned translations may also be put into the neural network of models 60-3. As such, the deep learning or training may be end-to-end such that the overall process is performed significantly faster in terms of the computational time. In doing so, rather than having discreet software modules implementing the herein-disclosed process, alignment component 36 may collapse some or all of such modules and put them directly into the weights of the neural network. Such a neural network (e.g., model 60-3) may create training data for the use of generating (e.g., training) high-precision automated feature extractors (pre-alignment model 60-2), e.g., via alignment component 36. An output of existing feature extractors (e.g., pre-alignment model 60-2) may, be obtained via pre-alignment component 34 and used by model 60-3. The alignment may thus be significantly better because effectively the ECC algorithm operates over significantly fewer relevant pixels.

In some embodiments, training component 32 may train a neural network end-to-end, e.g., with the ECC algorithm and other herein-disclosed functionality being collapsed or implemented in the neural network itself. As a result, the alignment process may be performed even faster in terms of computational time.

As depicted in the example of FIG. 4, hatching is used to indicate portions of road and/or pavement in that image, as per the feature detection raster of FIG. 3A. Also, in this example of FIG. 4, cross-hatching is used to indicate portions of road and/or pavement in that image, as per the rasterized vector labels of FIG. 3B. Also, in this example of FIG. 4, circles are used to represent foliage or vegetation, as per the feature detection raster of FIG. 3A, and other polygons filled with white are used to represent manufactured structure (e.g., buildings, cars, median of a street, etc.), as per the feature detection raster of FIG. 3A.

In some embodiments, the ECC algorithm is implemented in models 60-3 to fit a transformation, e.g., such that the lines of FIG. 3B fit the respective features of FIG. 3A. As such, the transformations are performed on the vectorized labels so that they more closely align the labels detected at the pixel level from the inputted imagery.

In some embodiments, the feature extractor network (e.g., model 60-2) may provide a plurality of features or feature vectors. Such extractor network may, e.g., be a deeper and densely connected backbone (e.g., ResNet, ResNeXt, AmoebaNet, AlexNet, VGGNet, Inception, etc.) or a more lightweight backbone (e.g., MobileNet, ShuffleNet, SqueezeNet, Xception, MobileNetV2, etc.), but any suitable neural network, feature extractor network, or convolutional network (e.g., CNN) is contemplated.

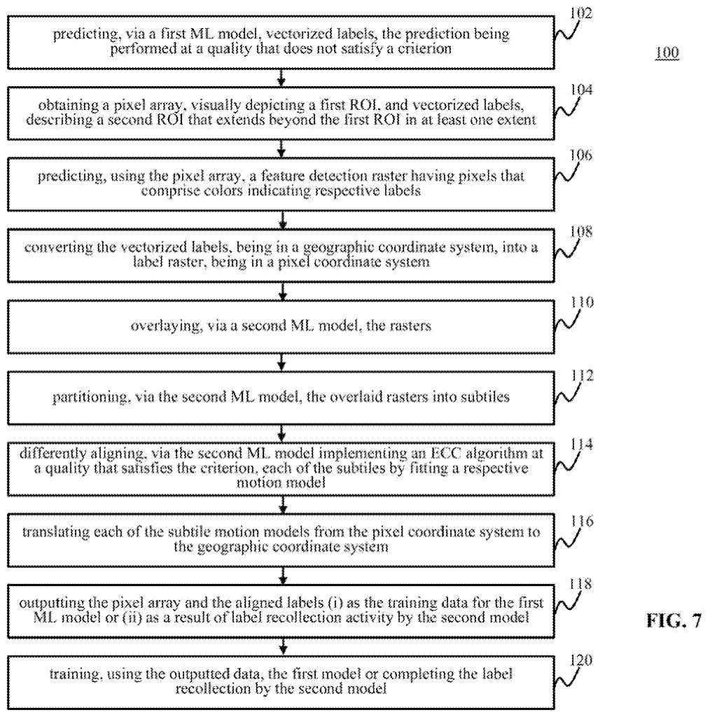

FIG. 7 illustrates method 100 for creating training data by better matching vectorized labels to reference imagery, in accordance with one or more embodiments. Method 100 may be performed with a computer system comprising one or more computer processors and/or other components. The processors are configured by machine-readable instructions to execute computer program components. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 7 and described below is not intended to be limiting. In some embodiments, method 100 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 100 in response to instructions stored electronically on an electronic storage medium. The processing devices may include one or more devices configured through hardware, firmware, and/or software to be specifically designed for execution of one or more of the operations of method 100.

At operation 102 of method 100, vectorized labels may be predicted, via a first ML model (e.g., model 60-2), the prediction being performed at a quality that does not satisfy a criterion. In some embodiments, operation 102 is performed by a processor component the same as or similar to pre-alignment component 34 (shown in FIG. 1 and described herein).

At operation 104 of method 100, a pixel array (e.g., FIG. 2A), visually depicting a first ROI, and vectorized labels (e.g., FIG. 2B), describing a second ROI that extends beyond the first ROI in at least one extent, may be obtained. As an example, each of the vectorized labels may indicate a road, pavement, or another type of object. In this or another example, the pixel array and the vectorized labels may be selected, based on a parameter, as a pair of datasets. In some embodiments, operation 104 is performed by a processor component the same as or similar to information component 30 (shown in FIG. 1 and described herein).

At operation 106 of method 100, a feature detection raster (e.g., FIG. 3A), having pixels that comprise colors, texture, or another form of emphasis indicating respective labels, may be predicted using the pixel array. As an example, each pixel of the feature detection raster may comprise a color (or form part of a textural pattern) indicating a label, the prediction resulting in at least two different colors (or textural patterns) being used in the feature detection raster. In some embodiments, operation 106 is performed by a processor component the same as or similar to pre-alignment component 34 or alignment component 36 (shown in FIG. 1 and described herein).

At operation 108 of method 100, the vectorized labels, being in a geographic coordinate system, may be converted into a label raster (e.g., FIG. 3B), being in a pixel coordinate system. In some embodiments, operation 108 is performed by a processor component the same as or similar to pre-alignment component 34 or alignment component 36.

At operation 110 of method 100, the feature detection raster may be superimposed on the label raster (e.g., FIG. 4), via a second ML model (e.g., model 60-3). In some embodiments, operation 110 is performed by a processor component the same as or similar to alignment component 36.

At operation 112 of method 100, the superimposed or overlaid rasters may be partitioned, via the second ML model, into subtiles. In some embodiments, operation 112 is performed by a processor component the same as or similar to alignment component 36 and model 60-3.

At operation 114 of method 100, each of the subtiles may be differently aligned (e.g., FIG. 5), via the second ML model implementing an ECC algorithm and via a fitting of a respective motion model, at a quality that satisfies the criterion. In some embodiments, operation 114 is performed by a processor component the same as or similar to alignment component 36 and model 60-3.

At operation 116 of method 100, each of the subtile motion models may be translated (e.g., FIG. 6A), from the pixel coordinate system to the geographic coordinate system. In some embodiments, operation 116 is performed by a processor component the same as or similar to alignment component 36 and model 60-3.

At operation 118 of method 100, the pixel array and the aligned labels may be outputted, (i) as the training data for the first ML model or (ii) as a result of label recollection activity by the second model. In some embodiments, operation 118 is performed by a processor component the same as or similar to information component 30.

At operation 120 of method 100, the first model may be re-trained (e.g., via training component 32 depicted in FIG. 1), using the outputted data, or the label recollection may be completed by the second model.

Techniques described herein may be implemented in digital electronic circuitry, or in computer hardware, firmware, software, or in combinations of them. The techniques may be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program may be written in any form of programming language, including compiled or interpreted languages, and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps of the techniques may be performed by one or more programmable processors executing a computer program to perform functions of the techniques by operating on input data and generating output. Method steps may also be performed by, and apparatus of the techniques may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory may be supplemented by or incorporated in special purpose logic circuitry.

Several embodiments of the invention are specifically illustrated and/or described herein. However, it will be appreciated that modifications and variations are contemplated and within the purview of the appended claims.

What is claimed is:

1. A computer-implemented method for creating training data, the method comprising:
obtaining (i) a pixel array visually depicting a first region of interest (ROI) and (ii) vectorized labels descriptive of a second ROI, wherein at least a portion of the first ROI overlaps the second ROI;
aligning, via a trained machine learning (ML) model, the vectorized labels to the pixel array, wherein the alignment is performed at a quality that satisfies a criterion; and
outputting the pixel array and the aligned labels as the training data for another ML model.

2. The method of claim 1, further comprising:
predicting, using the obtained pixel array, a feature detection raster, wherein each pixel of the feature detection raster comprises a color or forms part of a textural pattern to indicate a label, and wherein the prediction results in at least two different colors or textural patterns being used in the feature detection raster.

3. The method of claim 2, further comprising:
converting the vectorized labels into a label raster, wherein the vectorized labels are in a geographic coordinate system, and wherein the label raster is in a pixel coordinate system.

4. The method of claim 3, further comprising:
overlaying, via the trained ML model, the rasters; and
partitioning, via the trained ML model, the overlaid rasters into a plurality of sub-tiles,
wherein the alignment comprises fitting a motion model for each of the sub-tiles, to align the rasters, using an enhanced correlation coefficient (ECC) algorithm.

5. The method of claim 4, further comprising:
translating each of the sub-tile motion models from the pixel coordinate system to the geographic coordinate system.

6. The method of claim 1, further comprising:
predicting, via the other ML model, the vectorized labels, wherein the prediction is performed (i) at a quality that does not satisfy the criterion and (ii) before the vectorized labels are obtained; and
training, using the outputted training data, the other ML model.

7. The method of claim 1, wherein each of the pixel array and the vectorized labels is indiscriminately inputted from an external source.

8. The method of claim 2, wherein each of the indicated labels is selected from among (i) a road or pavement, (ii) vegetation, and (iii) manufactured structure.

9. The method of claim 1, wherein each of the vectorized labels indicates a road or pavement.

10. The method of claim 1, further comprising:
selecting, based on a parameter, the pixel array and the vectorized labels as a pair.

11. A method for label recollection, the method comprising:
automatically snapping, via a trained ML model, a set of vector labels by aligning one or more of the labels to an image, wherein the alignment is performed at a quality that satisfies a criterion, and wherein the image more recently represents a ROI than the set of vector labels; and
creating a label in and/or removing another label from the automatically snapped set of labels for a newly constructed feature and/or a newly destroyed feature, respectively.

12. The method of claim 11, further comprising:
obtaining training data from an output of another trained ML model.

13. The method of claim 11, further comprising:
predicting, via another ML model, the set of vector labels, wherein the prediction is performed (i) at a quality that does not satisfy the criterion and (ii) before the set of vector labels is obtained at the trained ML model.

14. The method of claim 11, further comprising:
truncating one or more vector labels of the set at locations that extend beyond the ROI of the image.

15. A non-transitory, computer-readable medium comprising instructions executable by at least one processor to perform a method, the method comprising:
aligning, via a trained ML model, the vectorized labels to a pixel array, wherein the pixel array visually depicts a first ROI, wherein the vectorized labels describe a second ROI, wherein the alignment is performed at a quality that satisfies a criterion; and
outputting the pixel array and the aligned labels as the training data for another ML model.

16. The computer-readable medium of claim 15, wherein the method further comprises:
predicting, using the obtained pixel array, a feature detection raster, wherein each pixel of the feature detection raster comprises a color indicating a label, and wherein the prediction results in at least two different colors being used in the feature detection raster.

17. The computer-readable medium of claim 16, wherein the method further comprises:
converting the vectorized labels into a label raster, wherein the vectorized labels are in a geographic coordinate system, and wherein the label raster is in a pixel coordinate system.

18. The computer-readable medium of claim 17, wherein the method further comprises:
overlaying, via the trained ML model, the rasters; and
partitioning, via the trained ML model, the overlaid rasters into a plurality of sub-tiles,
wherein the alignment comprises fitting a motion model for each of the sub-tiles, to align the rasters, using an enhanced correlation coefficient (ECC) algorithm.

19. The computer-readable medium of claim 18, wherein the method further comprises:
translating each of the sub-tile motion models from the pixel coordinate system to the geographic coordinate system.

20. The computer-readable medium of claim 15, wherein the method further comprises:
predicting, via the other ML model, the vectorized labels, wherein the prediction is performed (i) at a quality that does not satisfy the criterion and (ii) before the vectorized labels are obtained; and
training, using the outputted training data, the other ML model.
